(19) United States
(12) Patent Application Publication
(10) Pub. No.: US 2012/0010735 A1
(43) Pub. Date: Jan. 12, 2012

(54) Earpiece attaching system and method

(76) Inventor: Eyal Gilboa, Houston, TX (US)

(21) Appl. No.: 12/803,947

(22) Filed: Jul. 9, 2010

(51) Int. Cl. H04R 25/00; G06F 17/00

(52) U.S. Cl. 700/94; 381/370

(57) ABSTRACT

A device forming an earpiece is provided. The device includes a member generally shaped to fit within an ear of a person. The device further includes an adhesive coupled to the member, such that the adhesive is separable from the member. In addition, the adhesive is adapted to adhere the member to the ear.

### BACKGROUND

The present invention relates generally to earphones and more particularly to systems and methods for securely attaching earpieces.

There are situations where a user may desire to use earphones or earpieces even when such instances may not provide the most optimal or otherwise most convenient conditions for wearing or attaching such devices to the ear(s) of the user. For example, a swimmer may desire to listen to music or other audible programs while swimming, or while performing other aquatic workouts and the like. Notwithstanding current waterproof technologies of earphones, earpieces, etc., designed to protect the earpiece and its electrical components, delivery of clear and crisp audible sound to the user may, nonetheless, be hindered due to intervening fluid disposed within the ear canal. Accordingly, such fluid, i.e., water, may significantly attenuate and/or distort sounds, thereby depriving the user from enjoying the audible sounds originating from the earphones. By further example, an athlete, such as a jogger, utilizing earphones coupled to a portable media player may experience difficulties maintaining the earphones within the ear canals. In such instances, periodic movement and/or jolting during the physical activity of the jogger may cause the earphones or ear pieces to become displaced within the ear canal(s) to the extent audible sounds emanating from the earphone(s) become misdirected, attenuated and/or distorted. In other instances, perspiration accumulated in the ear canal(s) may cause the earphone(s) to slide or fall off the ear(s), thus, depriving the athlete from enjoying audible sounds uninterruptedly during a jog or any other physical exercise.

In other situations, when earphones are used for general listening purposes, such earphones may not exactly fit the ear, requiring the user to thrust or otherwise force the earphone to the ear canal of the user. Such application of the earphone may cause discomfort to the user, particularly after a prolonged of the earphone.

Accordingly, it is desirable to have earphones which are comfortable to wear and which avoid the above shortcomings.

### BRIEF DESCRIPTION

The disclosed methods and systems provide a device having a member, such as an ear phone, ear plug and/or a general ear piece, generally shaped to fit within an ear of a person. In one exemplary embodiment, the earpiece has an adhesive coupled to the member, such that the adhesive is separable from the member. The adhesive is further adapted to secure the member to the ear of the person. The adhesive may comprise a water absorbing adhesive, such as hydrogel, or other types of adhesives which can comfortably attach to or detach from an inner portion of the ear.

### DRAWINGS

These and other features, aspects, and advantages of the present invention will become better understood when the following detailed description is read with reference to the accompanying drawings in which like characters represent like parts throughout the drawings, wherein:

FIG. 1 illustrates perspective views of a strip attachable to an earpiece, in accordance with one embodiment of the present technique;

FIG. 2 is a side view of an earpiece, in accordance with one embodiment of the present technique;

FIG. 3 illustrates perspective views of another strip attachable to an earpiece, in accordance with an embodiment of the present technique;

FIG. 4 is a side view of the strip illustrated in FIG. 3, in accordance with one embodiment of the present technique;

FIG. 5 is a side view of another earpiece, in accordance with an embodiment of the present technique;

FIG. 6 is a side view of another earpiece, in accordance with an embodiment of the present technique;

FIG. 7 is a cross section view of yet another embodiment of the present technique;

FIG. 8 is a side view of an earpiece disposed within an ear canal, in accordance with an embodiment of the present technique; and

FIG. 9 is a perspective view of a media player in accordance with an embodiment of the present technique.

### DETAILED DESCRIPTION

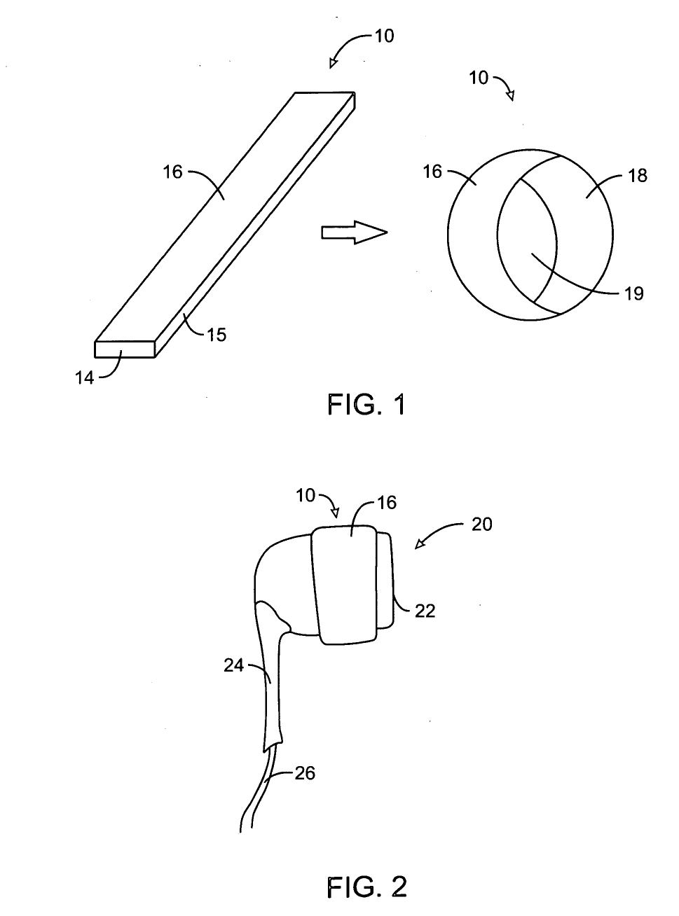

FIG. 1 illustrates a perspective view of a strip 10, or as otherwise referred to herein as a member, is adapted to be fitted on an earpiece, in accordance with an embodiment of the present technique. The member 10 may generally be comprised of a hydrogel or other types of adhesives, such as those adapted to for adhering to skin tissue.

The strip 10 member 10 has side 12 of a certain length, a side 14 of a certain width and a side 15 having a certain thickness. The lengths, widths and thickness, 12, 14, and 15, respectively, may be varied to have different sizes so that the member 10 may attain an overall general shape dictated by geometrical features and dimensions of an ear of an average person. The member 10 may have a body formed out of a mold, such as plastic, rubber, or other material or combinations of materials. The member 10 further includes an upper surface 16 exposing the hydrogel material so that the surface 16 may contact and/or adhere to any adjacent surface, such as skin or tissue. Those skilled in the art will appreciate that upon contacting a moist or otherwise wet surface, such as skin tissue, a molecular matrix forming the hydrogel member 10, particularly the surface 16, will absorb the moisture of and adhere to the surface by with which it makes contact. Consequently, the member 10 may expand in length, width, and/or thickness so as to contain any fluids, i.e., water that have entered and which have become part of the molecular matrix forming the member 10. As the surface to which the member 10 (via surface 16) dries off, the fluid absorbed and contained by the molecular matrix of the member 10 is released therefrom, causing the member 10 to retain its original size and shape.

As further illustrated by FIG. 1, the member 10 may generally be deformed to attain a general annular shape such that it forms a ring-like structure with the outer surface/portion 16 disposed on the outer surface of the annulus, and an inner surface/portion 18 disposed on the inner portion of the annulus formed by the member 10 when it is deformed. Accordingly, in its deformed state, the annulus 10 has an opening 19 through which an object and/or a device, such as an earpiece including an earphone, an earplug and/or other hearing and/or ear aids (as discussed further below), can be fitted. Hence, those skilled in the art may appreciate that the member 10 may generally posses elastic characteristics, enabling the member 10 to stretch, squeeze or otherwise be manipulated to attain various shapes when placed around an earphone such as that shown, for example, in FIG. 2. It should further be born in mind that the member 10 may be fabricated to attain various shapes and sizes so as to accommodate earpieces, such as but not limited to those mentioned above, to have various designs, shapes, colors and/or types.

Accordingly, FIG. 2 depicts on an earpiece 20 fitted with a member in accordance with an embodiment of the present technique. As noted herein and above, the term earpiece may include a part that fits in or is held next to an ear of a person. Accordingly, such a part may in an earphone, a hearing aid, an earplug, a wireless device, such as a Bluetooth or other wireless devices, or any portion of the aforementioned parts or devices.

Hence, in the illustrated exemplary embodiment, the earpiece 20 may be part of a set of headphones or other listening devices adapted to be placed within and/or in vicinity of the ear when worn by a user. In a preferred embodiment, the earpiece 20 may be fabricated to be water proof and/or water resistant, enabling the ear piece 20 to operate in aqueous environment. Accordingly, the earpiece 20 may be couplable to a water proof and/or a water resistant media player adapted to operate in an aqueous environment, as well. For example, in such an embodiment, the earpiece 20 may be used by swimmers, or other users who are submerged, partially submerged or are otherwise operating in aqueous environment. Accordingly, the earpiece 20 has an end portion 22 forming a speaker from where sounds can emanate and propagate through an ear canal. The earpiece 20 further includes another end portion 24 extending down and away from the end portion 22. The end portion 24 may be coupled to a wire 26 which provides electrical signals to the earpiece 20. Such electrical signals reach the earpiece 20 where they are ultimately converted, via internal transducers, into sound signals such as those audible to a listener. It should be born in mind that in other embodiments the wire 26 may be replaced by other extensions, such as antennas, for enabling the earpiece 20 to operate wirelessly. In such exemplary embodiments, the earpiece 20 may also include a receiver and other related components operable by battery, disposed within the earpiece 20 as well.

The illustrated embodiment further depicts the member 10 in its annular shape as disposed and circumscribing a mid portion of the earpiece 20. As discussed above, the member/annulus 10 may be configured to have various shapes and/or sizes so as to accommodate earpieces of various shapes and sizes. Accordingly, in the illustrated embodiment, the annulus fits cylindrically tightly and securely around the mid portion of the earpiece 20. In some embodiments for example, as discussed below, the inner portion 18 of the member 10 may include an adhesive or other coupling mechanisms adapted for coupling the annulus 10 to the earpiece 20. In such a configuration, a user can place the earpiece 20 near or within an ear such that the earpiece 20 may snuggly fit therein, enabling the hydrogel forming the layer 16 of the member/annulus 10 to contact and adhere to the skin tissue surrounding the ear. In one exemplary embodiment, the user may first fit the member 10 on the earpiece 20 and, thereafter, place the earpiece within the ear. In another embodiment, the earpiece 20 may already include a member, such as the member 10, coupled to the outer portion of the earpiece 20, such that the earpiece 20 is ready for use.

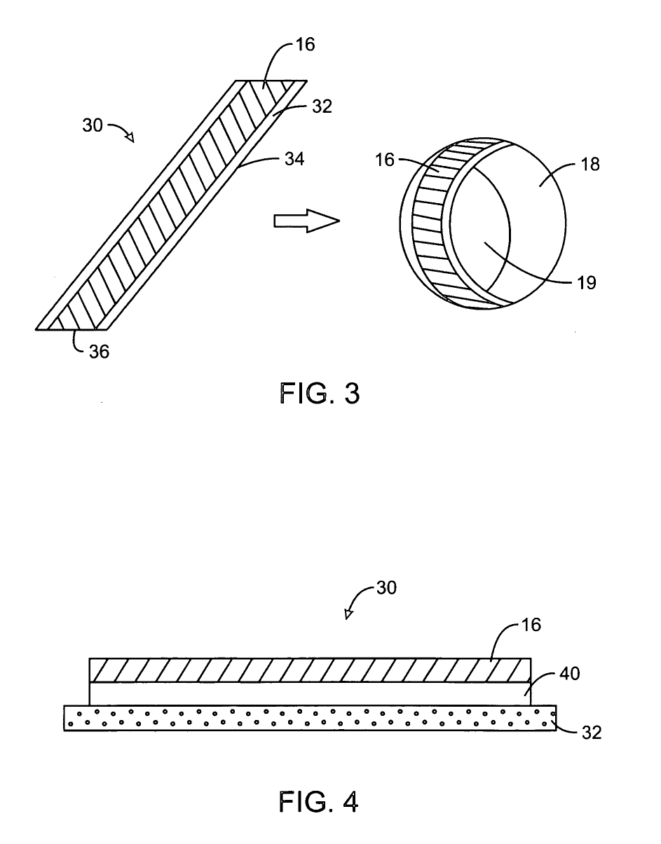

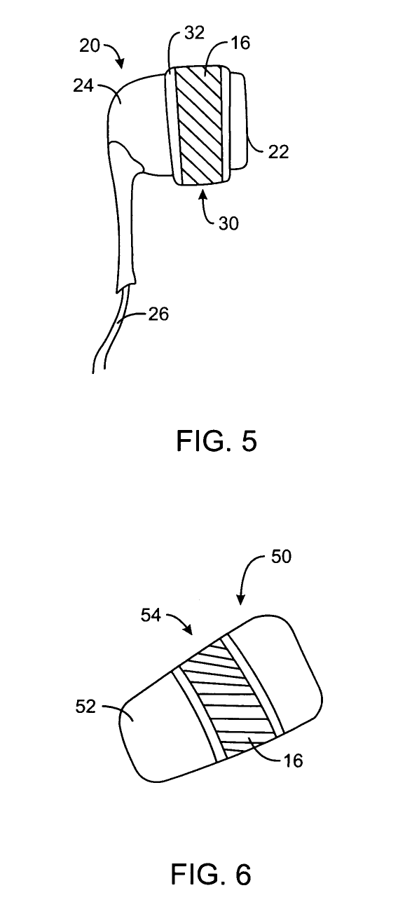

FIG. 3 is a perspective view of a strip/member 30, in accordance with an embodiment of the present technique. The member 30 is made of a lower portion 32 having length side 34 and width side 36. The member portion also includes an adhesive portion, such as the adhesive portion 16, adapted to be attachable to a person's tissue, such as outer skin tissue. As illustrated by FIG. 3, the member 30 is configurable to form an annulus in a manner similar to that achieved by the member 10. Hence, the member 30 can be shaped so that the member 30 to be fitted on an earpiece, as illustrated below by FIG. 5. As discussed above, the side length 34, the side width 36 and the adhesive 16 may be chosen to have various sizes so that the annulus 30 attains a desirable circumference for fitting along an earpiece of choice.

FIG. 4 is a side view of the member 30, in accordance with an embodiment of the present technique. As illustrated, the member 30 is a layered structure including the lower portion 32 and the adhesive, e.g., hydrogel, 16, placed on top of the lower strip 32. In accordance with one embodiment of the present technique, and adhesive layer 40 may be disposed between the layer 16 and the strip 32. Accordingly, the adhesive layer 40 ensures that the hydrogel 16 is securely affixed to the lower strip 32. Hence, the adhesive layer 40 may be made up of common known household glues, such as those used in masking tapes or other regular glues found in everyday use. In a preferred embodiment, the adhesive layer 40 should generally have good bonding abilities and should bond securely and with relative ease to the layers 16 and 32.

FIG. 5 depicts the earpiece 20 fitted with a member in accordance with an embodiment of the present technique. As noted herein and above, the term earpiece may include a part that fits in or is held next to an ear of a person. Accordingly, such a part may be in an earphone, a hearing aid, an earplug, a wireless device, such as a Bluetooth © or other wireless devices, or any portion of the aforementioned parts or devices.

Hence, in the illustrated exemplary embodiment, the earpiece 20 may be part of a set of headphones or other listening devices adapted to be placed within and/or in vicinity of the ear when worn by a user. In a preferred embodiment, the earpiece 20 may fabricated to be water proof and/or water resistant, enabling the ear piece 20 to operate in aqueous environment. Accordingly, the earpiece 20 may be couplable to a water proof and/or a water resistant media player adapted to operate in an aqueous environment as well. For example, in such an embodiment, the earpiece 20 may be used by swimmers, or other users who are submerged, partially submerged or are otherwise operating in aqueous environment. The additional features and characteristics of the earpiece 20, as described with relation to FIG. 2, are incorporated herein by reference.

As further illustrated by FIG. 5, the member 30 in its annular shape is disposed so as to circumscribe the mid portion of the earpiece 20. As discussed above, the member/annulus 30 may be configured to have various shapes and/or sizes so as to accommodate earpieces of various shapes and sizes. Accordingly, in the illustrated embodiment, the annulus fits cylindrically tightly and securely around the mid portion of the earpiece 20. This may be brought about by the lower/inner portion 32 of the member 30 which may fit tightly around the earpiece 20, or may otherwise incorporate and adhesive on its lower/inner surface for bonding securely to the surface of the earpiece 20. In such a configuration, a user can place the earpiece 20 near or within an ear such that the earpiece 20 may snuggly fit therein, enabling the hydrogel forming the layer 16 of the member/annulus 10 to contact and adhere to the skin tissue surrounding the ear. In one exemplary embodiment, the user may first fit the member 30 on the earpiece 20 and, thereafter, place the earpiece within the ear. In another embodiment, the earpiece 20 may already include a member, such as the member 30, coupled to the outer portion of the earpiece 20, readying the earpiece 20 for immediate use.

FIG. 6 is a side view of another earpiece, in accordance with an embodiment of the present technique. As illustrated and earpiece 50 may generally include devices, such as earplugs, swabs, silicon molds or other devices adapted to be inserted in or placed within close proximity to an ear. Such device may be adapted for temporary or otherwise prolonged use within the ear. Hence the member 50 may be generally shaped so that it fits conveniently within the ear, easily enabling its insertion and extraction in and out of the ear. In particular, the member 50 is formed of a portion 52 adapted to be inserted within the ear. Hence, the member 52 may be made up of a solid, such as plastic, rubber, silicon, foam, or any combination thereof. These and other similar materials from which the portion 52 may be made can render the portion 52 flexible and/or elastic. This may enable the user to manipulate and shape the portion 52 so that it can fit within the user's ear in accordance the shape of the user's ear(s).

As further illustrated, the member 50, particularly the member 54, may be fitted with an adhesive strip, such as the member 10 or the member 30 (FIGS. 1 and 3, respectively), having an adhesive 16 such as a hydrogel. Accordingly, the hydrogel or any other adhesive, adapted to use with skin tissue, is further adapted to secure and maintain the member 50 within the ear. As mentioned, in a preferred embodiment, the adhesive 16 may comprise a hydrogel adapted to absorb moisture from its surroundings, thereby adhering to the skin. In so doing, the hydrogel 16 keeps the member 50 snugly secured to the ear for prolonged durations or as may be desired.

It should be borne in mind that the member(s) discussed above, such as the member 10, are generally shaped independently of the earpieces, i.e., earpiece 20. Thus, the adhesive (e.g., hydrogel) forming the member 10 can fit a plurality of ear types having varying sizes and shapes. In addition, the hydrogel member 10 and, and those members similar to that member described herein and above, may conform to the varying shapes of those ears with which they male contact upon contacting the ears. Stated otherwise, the member 10 adjusts its shape in accordance with the ear while the member 10 is use.

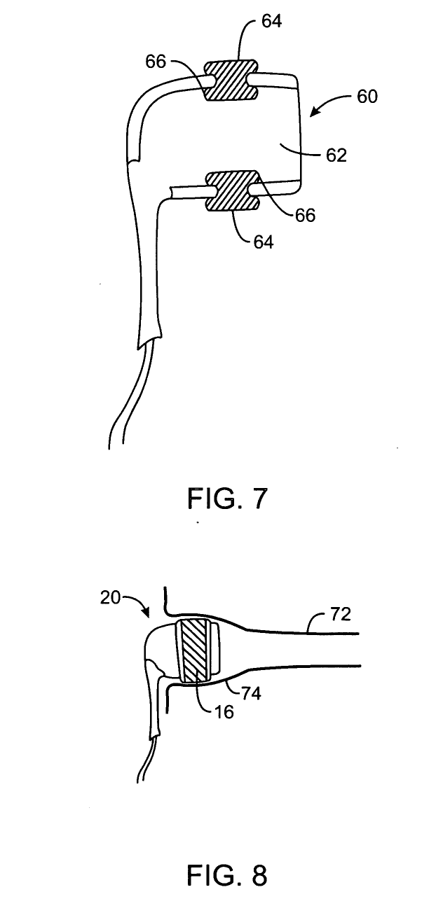

FIG. 7 is a cross section view of yet another embodiment of the present technique. Particularly, FIG. 7 depicts a cross section view of an earpiece 60, such as the ear piece 20 shown in FIGS. 2 and 5. Accordingly, the cross section is taken along line 1 of FIG. 1. In a preferred embodiment, the earpiece 60 has a main body portion 62 forming components of the ear piece 60. The earpiece 60 further has an adhesive 64 disposed in and around the ear 60 via the cavity 66. In other words, the cavity 66 etched, or engraved or otherwise formed within the main body 62 of the earpiece 60 is adapted to receive the adhesive 64. Hence, the adhesive 64 may be squeezed into and/ or glued to and within the cavity 66, such that it securely fits within the cavity 66. Thus, in a preferred embodiment, portions of the hydrogel may actually be disposed within the body 62 of the ear piece 60, while other portions of the hydrogel 64 may be disposed on the outside and/or on the surface of the main body 62. Such a configuration maintains the hydrogle securely fixed to the earpiece 60 at all times. As further illustrated, having portions of the hydrogel lodged within the earpiece 60 assures the hydrogel does not slide or otherwise move along or from the earpiece 60. Still further this configuration may also minimize and/or eliminate user contact with the hydrogel, thereby preserving and prolonging the integrity of the hydrogel so that it can be used many times.

As discussed above, the adhesive 64 is adapted to make contact and adhere to skin tissue of the ear, particularly to the opening of the ear. In a preferred embodiment, the adhesive 64 may be made up of a hydrogel or a similar water/moisture absorbing material adapted to adhere to skin tissue upon absorption of ambient water/moisture present within the vicinity of the opening of the ear. Accordingly, FIG. 8 depicts an earpiece placed within an ear, in accordance with an embodiment of the present technique. Thus, the ear piece 20 is illustrated as being within an ear opening 70 extending to an ear canal 72. As further illustrated, the ear piece 20 is held within the opening 70 via the hydrogel layer 16, which adheres to the skin tissue located on inner sides 74 of the ear opening 70. Hence, moisture secreted from or otherwise placed within and around the opening 70 can be absorbed by the hydrogel layer 16, thereby causing the hydrogel layer 16 to adhere to the inner portions of the ear 70. In this manner, the earpiece 20 is maintained securely within the ear opening 70, thereby minimizing slipping or movement of the earpiece 20 within the ear opening 70.

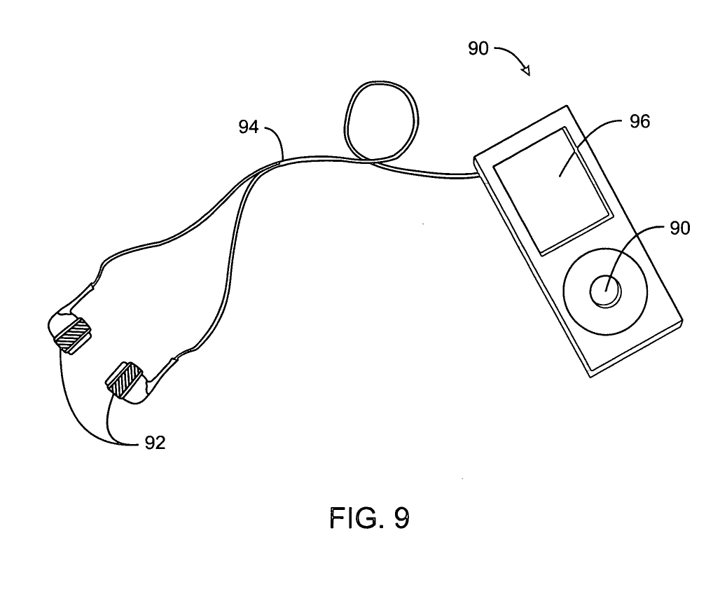

FIG. 9 illustrates a media player in accordance with an embodiment of the present technique. Media player 90 can be a portable media player, such as an iPod or other similar handheld portable devices adapted for storing and/or downloading media and/or other files. Accordingly, the portable media player may be a digital media player and may include memory devices, such as magnetic memory devices, optical memory devices, flash memory devices or a combination thereof for storing digital files. The media player 90 may include a display 96 for displaying images, alpha numeric symbols characters and/or other characters. The media player 90 may further include controls 98 for controlling/adjusting various features such as audio and/or display settings, including volume levels, display brightness levels, playlists shuffles, and so forth.

As further illustrated, the media player 90 is couple to a pair of earphones 92 via wire(s) 94. Each of the earphones 92 may be similar to the earphones/earpiece 20 described in FIGS. 2 and 5. Accordingly, the earphones 92 may include an adhesive layer, such as the hydrogel layer 16 (FIG. 1), adapted to adhere to the skin such as that located in an ear opening (FIG. 8).

While only certain features of the invention have been illustrated and described herein, many modifications and changes will occur to those skilled in the art. It is, therefore, to be understood that the appended claims are intended to cover all such modifications and changes as fall within the true spirit of the invention.

1. An ear device, comprising:
an earphone generally shaped to fit within an ear of a user; and
an adhesive coupled to the earphone, wherein the adhesive forms an annular strip circumscribing the earphone.

2. The device of claim 1, wherein the adhesive comprises a hydrogel adapted to absorb moisture from within and around the ear for adhering to the user.

3. The device of claim 2, wherein the hydrogel is glued to the earphone.

4. The device of claim 1, wherein the earphone is wireless.

5. The device of claim 1, wherein the adhesive is separable from the earphone

6. The device of claim 1, wherein the adhesive is deformable into to the annular strip by the user to fit around the earphone.

7. The device of claim 1, wherein the adhesive is disposable.

8. An ear device, comprising:
a member generally shaped to fit within an ear of a user; and
an adhesive disposed in and around the member.

9. The device of claim 8, wherein the adhesive comprises a hydrogel adapted to absorb moisture from within and around the ear so as to adhere to the ear.

10. The device of claim 8, wherein the member comprises an earphone.

11. The device of claim 8, wherein the member comprises an ear plug.

12. The device of claim 8, wherein the adhesive is seperable from the member.

13. A media player, comprising;
an electrical device adapted to store, process, and/or play audio and/or video media;
at least one ear phone coupled to the electrical device, the ear phone comprising; a member generally shaped to fit within an ear of a user; and
an adhesive coupled to the earphone, wherein the adhesive forms an annular strip circumscribing the earphone

14. The media player of claim 13, wherein the media comprises digital audio and/or video digital data.

15. The media player of claim 13, wherein the adhesive comprises a hydrogel.

16. The media player of claim 13, wherein the adhesive is disposed in and around the member.

17. The media player of claim 13, wherein the adhesive is separable from the earphone.

18. An adhesive adapted for use with an ear device, wherein the adhesive is generally shaped as a linear strip; and
wherein the strip is deformable into an annular member adapted to circumscribe the ear device.

19. The adhesive of claim 18, wherein the adhesive is disposed in and around the ear device.

20. The adhesive of claim 18, wherein the adhesive is comprised of hydrogel.
